(19) United States
(12) Patent Application Publication
(10) Pub. No.: US 2024/0376408 A1
(43) Pub. Date: Nov. 14, 2024

(54) Detergent Composition Comprising Laccase

(71) Applicant: Novozymes A/S, Bagsvaerd (DK)

(72) Inventors: Sidharth Ramanand, Herlev (DK); Shilpa Ramani, Bangalore (IN)

(73) Assignee: Novozymes A/S, Bagsvaerd (DK)

(21) Appl. No.: 18/318,470

(22) Filed: May 16, 2023

(30) Foreign Application Priority Data
May 10, 2023 (EP) 23172581.3

(51) Int. Cl. C11D 3/386; C11D 1/66; C11D 3/06; C11D 11/00; C11D 17/00; C11D 17/06

(52) U.S. Cl. CPC C11D 3/38636; C11D 1/662; C11D 3/062; C11D 3/38663; C11D 3/38672; C11D 17/0047; C11D 17/06; C11D 2111/12; C11D 2111/14

(57) ABSTRACT

The invention provides new detergent composition where phosphate partly or fully can be replaced by laccases, which leads to a reduced environmental impact compared to traditional phos-phate-based detergents while maintaining wash performance.

### CROSS-REFERENCE TO RELATED APPLICATIONS

This application is a U.S. national application, which claims priority or the benefit under 35 U.S.C. 119 of European application no. 23172581.3 filed May 10, 2023, the contents of which are fully incorporated herein by reference.

### REFERENCE TO SEQUENCE LISTING

This application contains a Sequence Listing in computer readable form. The contents of the electronic sequence listing created on May 12, 2023, named SQ_ST26.xml and 4 KB in size, is hereby incorporated by reference in its entirety.

### FIELD OF THE INVENTION

The present invention relates to powder detergent formulations wherein the amount of phos-phate is reduced by use of laccase.

### BACKGROUND OF THE INVENTION

Detergent compositions are well known to include a large number of ingredients, offering particular functionality throughout the cleaning process. However, some detergent ingredients have faced scrutiny due to potential environmental concerns most of all for not being sustainable because they are from a non-renewable source and are poorly biodegradable or even persistent in the environment. It is desirable to provide alternatives that have an improved sustainability profile while maintaining compatibility with other detergent ingredients. In addition, the consumer benefits and performance effects must be maintained.

Although laundry detergents have become generally phosphate-free in US and Europe, phos-phate remains a major ingredient in powder detergents in many parts of the world and contributes by its presence in the detergent to fabric color care and softness of the laundered textile. However, the use of phosphates comes with an environmental drawback as phosphates in wastewater is associ-ated with eutrophication of rivers and lakes. Accordingly, an unmet need remains for reduction of phosphate in detergents.

Laccases are oxidases that catalyze the oxidation of (poly)phenolic substrates by dioxygen and have been used among other for bleaching denim in the textile laundry sector as well as dye transfer inhibition (WO2015/185393).

The presence of a mediator, such as methyl syringate, violuric acid, or benzotriazole-1-ol, is often used in combination with the laccase, though laccases may also work without mediator, e.g., in polymerizing 2,4,6-trichloroanisol in wine corks to prevent musty cork taste.

### SUMMARY OF THE INVENTION

Maintenance of fabric softness and color are among the most prominent care-abouts for con-sumers when describing performance of laundry detergents. Color is the visual appearance of the fabric and ideally the fabric color is not affected negatively by the wash. Fabric softness can be related to compression and/or to smoothness and flexibility of fabrics and should also not be affected negatively by the wash.

Traditionally, phosphate has played a key role in laundry detergents when it comes to color care and maintenance of softness of the washed fabrics, but as discussed above the use of phos-phate has come under pressure, and the inventors of the present invention have surprisingly found that same improvement of color care and softness can be obtained by replacing phosphate partly or fully by laccase in the detergent composition. Further, the inventors of the present invention anticipate that this effect can be obtained even in the absence of mediators normally used in association with laccases

This is a major environmental improvement as the eutrophication of rivers and lakes may be decreased with reduced use phosphates in detergents.

In summary, the invention provides new detergent compositions comprising:
1) less phosphate than the amount of phosphate corresponding to 0.2% STP;
2) an enzyme having laccase activity and optionally at least one more enzyme;
3) at least one surfactant; and
4) optionally a laccase oxidase mediator.

The detergent compositions of the invention allow phosphate to be partly or fully replaced by laccases and thus enable a reduced environmental impact compared to traditional phosphate-based detergents while maintaining wash performance.

### DETAILED DESCRIPTION OF THE INVENTION

### Definitions

In accordance with this detailed description, the following definitions apply. Note that the singular forms “a”, “an”, and “the” include plural references unless the context clearly dictates otherwise.

The pH of the formulation is that of 2 g/L solution of the laundry detergent composition dissolved in one liter of demineralised water at 25° C.

Unless defined otherwise or clearly indicated by context, all technical and scientific terms used herein have the same meaning as commonly understood by one of ordinary skill in the art to which this invention belongs.

Unless defined otherwise or clearly indicated by context, all component levels provided herein are made in reference to the active level of that component.

Percentage of a product is the product in protonated form where relevant.

All percentages and ratios of components are calculated by weight unless otherwise indicated. All percentages are calculated based on the total composition unless otherwise indicated.

### AlphaFold Structure Prediction

AlphaFold is a computational method for predicting the three-dimensional structure of a polypeptide from its amino acid sequence (Jumper et al., Highly accurate protein structure prediction with AlphaFold. Nature, 2021). Predicted structures for millions of polypeptides deposited in the UniProt database have been deposited in the AlphaFold Protein Structure Database, using the AlphaFold Monomer v2.0 model (Varadi et al. AlphaFold Protein Structure Database: massively ex-panding the structural coverage of protein-sequence space with high-accuracy models. Nucleic Acids Research, 2021). In the AlphaFold Protein Structure Database, the three-dimensional structure of a polypeptide can be obtained by searching for the UniProt accession number of the polypeptide.

In addition to the many three-dimensional structures that are already publicly available, code is available for reproducing and predicting structures of new polypeptides at source code repositories such as Github.com under deepmind/alphafold/, using notebooks/AlphaFold.ipynb, which uses Alphafold v2.3.1 or newer. Additionally, it can be found in Github.com under sokrypton/ColabFold using v1.5.2 or newer, using AlphaFold2.ipynb. For technical details, please see Jumper et al. (vide supra).

AlphaFold produces a per-residue estimate of its confidence on a scale from 0 to 100. This confidence measure is called pLDDT and corresponds to the model's predicted score on the IDDT-Cαmetric. It is stored in the B-factor fields of the mmCIF and PDB files available for download (although unlike a B-factor, higher pLDDT is better). Regions with pLDDT score of more than 90 are expected to be modelled to high accuracy. These should be suitable for any application that benefits from high accuracy (e.g., characterization of binding sites). Regions with a pLDDT score between 70 and 90 are expected to be modelled well, corresponding to a generally good backbone prediction.

### Biobased Surfactants

As used herein biobased surfactants are a commercial or industrial product (other than food or feed) that is composed, in whole or in significant part, of biological products or renewable agricultural materials or forestry materials and/or as established by European standard EN 16575:2014. In particular rhamnolipids and sophorolipids may be used a detergent ingredient.

### Color Care

By the term “color care”, as used herein, is meant the partial or full restoration the visual appearance of the initial colors of textile upon wash. Improved color care is indicated by lower delta remission value (ARem) values as described in the section Examples, Method for evaluation of fabric color care benefits.

### Detergent Composition

The term “detergent composition” refers to compositions that find use in the removal of undesired compounds from items to be cleaned, such as textiles, dishes, and hard surfaces. The detergent composition may be used to e.g. clean textiles, dishes and hard surfaces for both household cleaning and industrial cleaning and/or for fabric care. The terms encompass any materials/compounds selected for the particular type of cleaning composition desired and the form of the product (e.g., liquid, gel, powder, granulate, paste, or spray compositions) and includes, but is not limited to, detergent compositions (e.g., liquid and/or solid laundry detergents and fine fabric detergents; hard surface cleaning formulations, such as for glass, wood, plastic, ceramic and metal counter tops and windows; carpet cleaners; oven cleaners; fabric fresheners; fabric softeners; and textile and laundry pre-spotters, as well as dish wash detergents).

In addition to containing an enzyme of the invention, the detergent formulation may contain one or more additional enzymes (such as amylases, proteases, peroxidases, cellulases, betaglucanases, xyloglucanases, hemicellulases, xanthanases, xanthan lyases, lipases, acyl transferases, phospholipases, esterases, laccases, catalases, aryl esterases, amylases, alpha-amylases, glucoamylases, cutinases, pectinases, pectate lyases, keratinases, reductases, oxidases, phenoloxidases, lipoxygenases, ligninases, carrageenases, pullulanases, tannases, arabinosidases, hyaluronidases, chondroitinases, xyloglucanases, xylanases, pectin acetyl esterases, polygalacturonases, rhamnogalacturonases, other endo-beta-mannanases, exo-beta-mannanases (GH5 and/or GH26), licheninases, phosphodiesterases, pectin methylesterases, cellobiohydrolases, transglutaminases, nucleases, and combinations thereof, or any mixture thereof), and/or detergent components such as surfactants, hydrotropes, builders, co-builders, chelators or chelating agents, bleaching system or bleach components, polymers, fabric hueing agents, fabric conditioners, foam boosters, suds suppressors, dispersants, dye transfer inhibitors, fluorescent whitening agents, perfume, tannish inhibitors, optical brighteners, bactericides, fungicides, soil suspending agents, soil release polymers, anti-redeposition agents, enzyme inhibitors or stabilizers, enzyme activators, antioxidants, and solubilizers. The detergent composition may comprise of one or more of any type of detergent component.

### Hybrid Polypeptide

The term “hybrid polypeptide” means a polypeptide comprising domains from two or more polypeptides from different sources (origins), e.g., a binding module from one polypeptide and a catalytic domain from another polypeptide. The domains may be fused at the N-terminus or the C-terminus. Of particular interest herein are polypeptides comprising a binding module from one polypeptide (which may be naturally occurring or further modified), an engineered linker region, such as a proline-rich linker region, which is a synthetic construct, and a catalytic domain from another polypeptide (which may be naturally occurring or further modified).

### Improved Wash Performance

The term “improved wash performance” is defined herein as an enzyme displaying an increased wash performance in a detergent composition relative to the wash performance of a reference detergent composition, e.g., by increased color care and/or softness.

### Laccase

The term “laccase” means a polypeptide having polyphenol oxidase activity (EC 1.10.3.2) that catalyzes the oxidation of a variety of inorganic and aromatic compounds, particularly phenols, with the concomitant reduction of molecular oxygen to water.

Laccase activity can be measured using 2,2′-azino-bis (3-ethylbenzothiazoline-6-sulfonic acid) diammonium salt (ABTS, CAS number: 30931-67-0) as substrate in 100 mM sodium acetate pH 4 and measuring the absorbance at 405 nm according to the procedure described in the section Examples, Assay for laccase activity.

The laccases of the present invention have at least 20%, e.g., at least 40%, at least 50%, at least 60%, at least 70%, at least 80%, at least 90%, at least 95%, or at least 100% of the laccase activity of the Myceliophthora thermophila laccase having Uniprot accession number G2QG31.

### Laccase Redox Mediators (Enhancers)

Laccase redox mediators (or just “mediators”) include, but are not limited to, diammonium salt of 2,2′-azine-bis(3-ethylbenzothiazoline-6-sulfonic acid (ABTS), methyl syringate, 2,2′,6,6′-tetramethyl-1-piperidinyloxyl (TMPO), 1-hydroxybenzotriazole (HBT), 3-hydroxyanthranilic acid, 3-hydroxyanthranilic acid (HPI), violuric acid (VA), phenothiazine, phenothiazine-10-propionic acid, promazine, chloropromazine, and 1-nitroso-2-naphthol-3,6-disulfonic acid, 2-nitroso-1-naphthol-4-sulfonic acid. Further organic compounds are known as potential laccase mediators, see e.g. Morozowa et al.: Applied Biochemistry and Microbiology, 2007, Vol. 43, No. 5, pp. 523-535 “Laccase-Mediator Systems and Their Applications: A Review.

### Laccase System

The term “laccase system” means the Myceliophthora thermophila laccase having Uniprot accession number G2QG31 in combination sodium dihygrogen phosphate (NaH₂PO₄) and methyl syringate.

### Laundering

The term “laundering” relates to household laundering and/or industrial laundering and means the process of treating textiles with a solution containing a cleaning or detergent composition of the present invention. The laundering process can for example be carried out using e.g. a household or an industrial washing machine or can be carried out by hand.

### Methyl Syringate

Methyl syringate is an efficient phenolic mediator for bacterial and fungal laccases.

### Parent or Parent Laccase

The term “parent” or “parent laccase” means a laccase to which an alteration is made to pro-duce the enzyme variants of the present invention. For the purpose of the present invention, the Myceliophthora thermophila laccase having Uniprot accession number G2QG31 is considered the parent laccase.

### Structural Similarity

The relatedness between two amino acid sequences has conventionally been described by the parameter “sequence identity”. However, since the biological function of a polypeptide is defined by its three-dimensional structure rather than its amino acid sequence, a better way of assessing a functional relationship between polypeptides is by comparing their three-dimensional structures. Thus, for the purposes of the present invention, the relatedness between the three-dimensional structure of two polypeptides is described by the parameter “structural similarity”.

A three-dimensional structure of any polypeptide may be obtained experimentally via, e.g., X-ray crystallography or using in silico methods such as AlphaFold (vide supra). The structural similarity between three-dimensional structures may then be determined by the TM-score, which is calculated using the following general formula (Zhang & Skolnick, Proteins 57:702-710, 2004):

$$TM - score = Max [ \frac{1}{{L}_{N}} {\sum }_{i = 1}^{{L}_{T}} \frac{1}{1 + {( \frac{{d}_{i}}{{d}_{0}} )}^{2}} ]$$

where L_{N} is the length of the native structure, L_{T} is the length of the aligned residues to the template structure, di is the distance between the ith pair of aligned residues and do is a scale to normalize the match difference. ‘Max’ denotes the maximum value after optimal spatial superposition.

For the purposes of the present invention, L_{N} is always the length of the reference protein, indicating the use of a fixed reference length L to prevent artificially large TM-scores from alignment of substructures:

$$TM - score = \frac{1}{L} {\sum }_{i = 1}^{{L}_{T}} \frac{1}{1 + {( \frac{{d}_{i}}{{d}_{0}} )}^{2}}$$

A structural alignment of the three-dimensional structure of two polypeptides is necessary before the TM-score can be calculated. This is achieved via algorithms that optimize the structural overlap, and several methods are available, such as CEalign (Shindyalov and Bourne, Protein Eng., 11, 739-747, 1998), DALI (Holm and Sander, Trends Biochem. Sci., 20, 478-480, 1995), or TM-align (Nucleic Acids Res. 33:2302-2309, 2005).

For the purposes of the present invention, TM-align is applied. For convenience, TM-score is integrated in the TM-align software, which is available from the author's website. The version of TM-align is preferably updated 2019 Aug. 22 or later, and the TM-score between a reference and query protein is determined by running this command:
TMalign <query.pdb><reference.pdb>—L<length of reference>

Where <query.pdb> is the name of the PDB file containing coordinates of the query polypeptide, <reference.pdb> is the name of the PDB file containing coordinates of the reference polypeptide. The TM-score is calculated and reported in the output, along with several other parameters from the alignment.

### Sodium Triphosphate (STP)

STP has the chemical formula Na₅P₃O₁₀. STP is may also be referred to as sodium tripolyphosphate (STPP).

### Softness

Softness is a subjective, tactile sensation perceived by a user when the skin comes in contact with a textile surface. A complex mix of tensile, shear and bending properties, compressibility and surface friction properties of the fabric determine the sensation experienced. In the context of the present invention softness is measured as a panel score as outlined in the section Experimental, Method for evaluation of fabric softness benefits.

### Textile

The term “textile” means any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used, it is intended to include the broader term textiles as well.

### Variant

The term “variant” means a polypeptide having laccase activity comprising single or multiple amino acid substitutions, deletions, and/or insertions at one or more (e.g., several) positions in parent laccase. A “variant” as used herein may also include a hybrid polypeptide.

### Wash Liquor/Wash Solution

The term “wash liquor” refers to an aqueous solution containing a detergent composition in dilute form, such as but not limited to a detergent solution containing a laundry detergent composition in dilute form such as the wash liquor in a laundry process.

### Wash Performance

The ability to maintain or improve color and/or softness of the fabric.

### Use of Laccase in Laundry Detergent

The present invention relates to a detergent composition comprising
1) less phosphate than the amount of phosphate corresponding to 0.2% STP;
2) an enzyme having laccase activity and optionally at least one more enzyme;
3) at least one surfactant; and
4) optionally a laccase oxidase mediator.

The present invention further relates to the use of said detergent composition, particularly in a laundering process.

The inventors of the present invention have surprisingly found that the use of laccase in detergent allows for low phosphate concentrations while maintaining color care and in particular softness of the laundered textile.

Laccase belongs to EC 1.10.3.2, i.e., oxidoreductases acting of diphenols with oxygen as ac-ceptor. In the context of the present application, the Myceliophthora thermophila laccase having Uniprot accession number G2QG31 has been tested, but any laccase may be useful and in a broader context it is envisaged that oxidoreductases may be useful. In particular, it is considered that enzymes having laccase activity and a TM-score of at least 0.60, e.g., at least 0.65, at least 0.70, at least 0.75, at least 0.80, at least 0.85, at least 0.90, at least 0.91, at least 0.92, at least 0.93, at least 0.94, at least 0.95, at least 0.96, at least 0.97, at least 0.98, at least 0.99, or even 1.0, compared to the three-dimensional structure of the polypeptide having UniProt accession number G2QG31 are useful in detergent compositions of the present invention.

Surfactants are important for the performance of detergents, including laundry detergents. Useful surfactants are mentioned in the section “Surfactants” as well as in the specific formulations of the model detergents I and II applied in the experimental setup. Preferably, the surfactants are from renewable sources, i.e., are biobased. Biobased surfactants are composed, in whole or in significant part, of biological products or renewable agricultural materials or forestry materials and/or as established by European standard EN 16575:2014. In particular rhamnolipids and sophorolipids may be used a detergent ingredient.

Almost all detergents, in particular laundry detergents, comprise a combination of enzymes from different enzyme classes such as a protease, lipase, cutinase, amylase, carbohydrase, DNase, pectinase, mannanase, arabinase, galactanase, xylanase, and peroxidase. In particular proteases is found in almost all (laundry) detergents, but mannanase, DNase, lipase, pectinase and cellulases are also often present. Cellulases also contribute to color care and softness laccase has been found to be able to. Consequently, the presence of both cellulase and laccase may be beneficial for color care as well as for softness.

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid. The various detergent compositions are disclosed in more detail in the paragraph “Detergent compositions, enzymes and enzyme formulations”, in particular reference is made to the paragraphs “Detergent compositions” and “Formulation of detergent products”.

Depending on the format of the detergent composition enzymes may be added in the form of liquid enzyme preparations, encapsulated enzyme formulations or granular enzyme formulations, the latter also in the form of co-granulates comprising more than one enzyme. Liquid enzyme preparations may, for instance, be stabilized by adding a polyol such as propylene glycol, a sugar or sugar alcohol, lactic acid or boric acid according to established methods.

The detergent composition of the present invention may be formulated, for example, as a hand or machine laundry detergent composition including a laundry additive composition suitable for pre-treat-ment of stained fabrics or for rejuvenating textile (e.g. by fuzz or pill removal, restore softness) to restore some of the visual and feel properties of fabrics after extended use to match that of a new textile, and a rinse added fabric softener composition, or be formulated as a detergent composition for use in general household hard surface cleaning operations, or be formulated for hand or machine dishwashing operations. In particular, the detergent composition of the invention may be useful for color care or obtaining softness of textile in laundering process.

The composition of the present invention may be used in a method of cleaning an item, comprising exposing the item to a wash liquor comprising the detergent composition of the invention, wherein the item is a textile or a hard surface.

### Detergent Compositions, Enzymes and Enzyme Formulations

### Detergent Compositions

In one embodiment, the invention is directed to detergent compositions comprising an enzyme of the present invention in combination with one or more additional cleaning composition components. The choice of additional components is within the skill of the artisan and includes conventional ingredients, including the exemplary non-limiting components set forth below. Additional, optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in laundry detergents may be utilized. The choice of such ingredients is well within the skill of the artisan.

The choice of components may include, for textile care, the consideration of the type of textile to be cleaned, the type and/or degree of soiling, the temperature at which cleaning is to take place, and the formulation of the detergent product. Although components mentioned below are categorized by general header according to a particular functionality, this is not to be construed as a limitation, as a component may comprise additional functionalities as will be appreciated by the skilled artisan.

In one embodiment, the invention is directed to a liquid laundry detergent composition comprising an enzyme of the present invention in combination with one or more additional laundry detergent composition components, specifically a protease. In another embodiment, the invention comprises an ancil-lary product used in laundry, such as a prespotter or stain removal booster. The present invention also relates to an ADW (Automatic Dish Wash) compositions comprising an enzyme of the present invention in combination with one or more additional ADW composition components. The choice of additional components is within the skill of the artisan and includes conventional ingredients, including the exemplary non-limiting components set forth below.

### Surfactants

Typically, the detergent composition comprises (by weight of the composition) one or more surfactants in the range of 0% to 50%, preferably from 2% to 40%, more preferably from 5% to 35%, more preferably from 7% to 30%, most preferably from 10% to 25%, even most preferably from 15% to 20%. In a preferred embodiment the detergent is a liquid or powder detergent comprising less than 40%, preferably less than 30%, more preferably less than 25%, even more preferably less than 20% by weight of surfactant. The composition may comprise from 1% to 15%, preferably from 2% to 12%, 3% to 10%, most preferably from 4% to 8%, even most preferably from 4% to 6% of one or more surfactants. Preferred surfactants are anionic surfactants, non-ionic surfactants, cationic surfactants, zwitterionic surfactants, amphoteric surfactants, and mixtures thereof.

Suitable anionic surfactants are well known in the art and may comprise fatty acid carboxylates (soap), branched-chain, linear-chain and random chain alkyl sulfates or fatty alcohol sulfates or pri-mary alcohol sulfates or alkyl benzenesulfonates such as LAS and LAB or phenylalknesulfonates or alkenyl sulfonates or alkenyl benzenesulfonates or alkyl ethoxysulfates or fatty alcohol ether sulfates or alpha-olefin sulfonate or dodecenyl/tetradecnylsuccinic acid. The anionic surfactants may be alkoxylated. The detergent composition may also comprise from 1 wt % to 10 wt % of non-ionic surfactant, preferably from 2 wt % to 8 wt %, more preferably from 3 wt % to 7 wt %, even more preferably less than 5 wt % of non-ionic surfactant.

Suitable non-ionic surfactants are well known in the art and may comprise alcohol ethoxylates, and/or alkyl ethoxylates, and/or alkylphenol ethoxylates, and/or glucamides such as fatty acid N-glucosyl N-methyl amides, and/or alkyl polyglucosides and/or mono- or diethanolamides or fatty acid amides. The detergent composition may also comprise from 0 wt % to 10 wt % of non-ionic surfactant, preferably from 0.1 wt % to 8 wt %, more preferably from 0.5 wt % to 7 wt %, even more preferably less than 5 wt % of non-ionic surfactant.

Suitable cationic surfactants are well known in the art and may comprise alkyl quaternary am-monium compounds, and/or alkyl pyridinium compounds and/or alkyl quaternary phosphonium compounds and/or alkyl ternary sulphonium compounds. The detergent composition may also comprise from 0 wt % to 10 wt % of cationic surfactant, preferably from 0.1 wt % to 8 wt %, more preferably from 0.5 wt % to 7 wt %, even more preferably less than 5 wt % of cationic surfactant.

The composition preferably comprises surfactant in an amount to provide from 100 ppm to 5,000 ppm surfactant in the wash liquor during the laundering process. The composition upon contact with water typically forms a wash liquor comprising from 0.5 g/I to 10 g/I detergent composition. Many suitable surface active compounds are available and fully described in the literature, for example, in “Surface-Active Agents and Detergents”, Volumes I and 11, by Schwartz, Perry and Berch. Also preferred are biobased surfactants, which may be wholly biobased (>95% biobased carbon of total carbon according to European standard EN 17035). As used herein biobased surfactants are a commercial or industrial product (other than food or feed) that is composed, in whole or in significant part, of biological products or renewable agricultural materials or forestry materials and/or as established by European standard EN 16575:2014. In particular rhamnolipids and sophorolipids may be used a detergent ingredient.

### Solvent System

For dissolution of the surfactant and other detergent ingredients, a solvent system is needed. Solvents are typically water, alcohols, polyols, sugars and/or mixtures thereof. Preferred solvents are water, glycerol, sorbitol, propylene glycol (MPG, 1,2-propanediol or 1,3-propane diol), dipropylene glycol (DPG), polyethylene glycol family (PEG300-600), hexylene glycol, inositol, mannitol, Ethanol, isopropanol, n-butoxy propoxy propanol, ethanolamines (monoethanol amine, diethanol amines and triethanol amines), sucrose, dextrose, glucose, ribose, xylose, and related mono and di pyranosides and furanosides. The solvent system is present in typically totally 5-90%, 5-60%, 5-40%, 10-30% by weight.

### Hydrotropes

A hydrotrope is a compound that solubilises hydrophobic compounds in aqueous solutions (or oppositely, polar substances in a non-polar environment). Typically, hydrotropes have both hydro-philic and a hydrophobic character (so-called amphiphilic properties as known from surfactants), however the molecular structure of hydrotropes generally do not favor spontaneous self-aggregation, see e.g. review by Hodgdon and Kaler (2007), Current Opinion in Colloid & Interface Science 12: 121-128. The detergent may contain 0-10% by weight, for example 0-5% by weight, such as about 0.5 to about 5%, or about 3% to about 5%, of a hydrotrope.

### Builders and Co-Builders

The detergent composition may contain about 0-65%, 0-20%; or 0.5-5% of a detergent builder or co-builder, or a mixture thereof. In a dish wash detergent, the level of builder is typically 10-65%, particularly 20-40%. The builder and/or co-builder may particularly be a chelating agent that forms water-soluble complexes with Ca and Mg. Any builder and/or co-builder known in the art for use in laundry detergents may be utilized.

### Bleaching Systems

The detergent may contain 0-30% by weight, such as about 1% to about 20%, of a bleaching system. Any bleaching system known in the art for use in laundry detergents may be utilized.

### Polymers

The detergent may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs.

### Fabric Hueing Agents

The detergent compositions of the present invention may also include fabric hueing agents such as dyes or pigments, which when formulated in detergent compositions can deposit onto a fabric when said fabric is contacted with a wash liquor comprising said detergent compositions and thus altering the tint of said fabric through absorption/reflection of visible light.

### Dispersants

The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

### Dye Transfer Inhibiting Agents

The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

### Soil Release Polymers

The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore random graft co-polymers are suitable soil release polymers. Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose deriviatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitter-ionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.

### Anti-Redeposition Agents

The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.

### Rheology Modifiers

Rheology modifiers are structurants or thickeners, as distinct from viscosity reducing agents. The rheology modifiers are selected from the group consisting of non-polymeric crystalline, hydroxy-functional materials, polymeric rheology modifiers which impart shear thinning characteristics to the aqueous liquid matrix of a liquid detergent composition. The rheology and viscosity of the detergent can be modified and adjusted by methods known in the art, for example as shown in EP 2169040.

### Other Suitable Adjunct Materials

Other adjunct materials include, but are not limited to, anti-shrink agents, anti-wrinkling agents, bactericides, binders, carriers, dyes, enzyme stabilizers, fabric softeners, fillers, foam regulators, perfumes, pigments and sod suppressors.

### Additional Enzymes

The detergent additive as well as the detergent composition may comprise one or more additional enzymes such as a protease, lipase, cutinase, an amylase, carbohydrase, DNase, pectinase, mannanase, arabinase, galactanase, xylanase, and oxidase (e.g., peroxidase).

In general, the properties of the selected enzyme(s) should be compatible with the selected detergent, (i.e., pH-optimum, compatibility with other enzymatic and non-enzymatic ingredients, etc.), and the enzyme(s) should be present in effective amounts.

### Cellulase

The term “cellulase” or “celluloytic enzyme” means one or more (e.g., several) enzymes that hydrolyze a cellulosic material. The two terms polypeptide having cellulase activity and cellulase are used interchangeably. Cellulases may be selected from the group consisting of cellulases belonging to GH5, GH44, GH45, EC 3.2.1.4, EC 3.2.1.21, EC 3.2.1.91 and EC 3.2.1.172. Such enzymes include endoglucanase(s) (e.g. EC 3.2.1.4), cellobiohydrolase(s), beta-glucosidase(s), or combinations thereof.

Suitable cellulases include mono-component and mixtures of enzymes of bacterial or fungal origin. Chemically modified or protein engineered mutants are also contemplated. The cellulase may for example be a mono-component or a mixture of mono-component endo-1,4-beta-glucanase also referred to as endoglucanase.

Suitable cellulases include those from the genera Bacillus, Pseudomonas, Humicola, Myceliophthora, Fusarium, Thielavia, Trichoderma, and Acremonium. Exemplary cellulases include a fungal cellulase from Humicola insolens (U.S. Pat. No. 4,435,307) or from Trichoderma, e.g. T. reesei or T. viride. Other suitable cellulases are from Thielavia e.g. Thielavia terrestris as described in WO 96/29397 or the fungal cellulases produced from Myceliophthora thermophila and Fusarium ox-ysporum disclosed in U.S. Pat. Nos. 5,648,263, 5,691,178, 5,776,757, WO 89/09259 and WO 91/17244. Also relevant are cellulases from Bacillus as described in WO 02/099091 and JP 2000210081. Suitable cellulases are alkaline or neutral cellulases having care benefits. Examples of cellulases are described in EP 0 495 257, EP 0 531 372, WO 96/11262, WO 96/29397, WO 98/08940. Other examples are cellulase variants such as those described in WO 94/07998, EP 0 531 315, U.S. Pat. Nos. 5,457,046, 5,686,593, 5,763,254, WO 95/24471, WO 98/12307.

Other cellulases are endo-beta-1,4-glucanase enzyme having a sequence of at least 97% identity to the amino acid sequence of position 1 to position 773 of SEQ ID NO:2 of WO 2002/099091 or a family 44 xyloglucanase, which a xyloglucanase enzyme having a sequence of at least 60% identity to positions 40-559 of SEQ ID NO: 2 of WO 2001/062903.

Commercially available cellulases include Carezyme®, Carezyme® Premium, Celluzyme®, Celluclean®, Celluclast®, Endolase®, Renozyme®; Whitezyme® Celluclean® Classic, Cellusoft® (Novozymes A/S), Puradax®, Puradax HA, and Puradax EG; Revitalenz 1000; Revitalenz 200; Revitalenz 2000 (Dupont Industrial Biosciences), KAC-500(B)O (Kao Corporation), Biotouch DCL; Biotouch FLX1 (AB enzymes).

The two basic approaches for measuring cellulolytic enzyme activity include: (1) measuring the total cellulolytic enzyme activity, and (2) measuring the individual cellulolytic enzyme activities (endoglucanases, cellobiohydrolases, and beta-glucosidases) as reviewed in Zhang et al., 2006, Bio-technology Advances 24: 452-481. Total cellulolytic enzyme activity can be measured using insoluble substrates, including Whatman NW1 filter paper, microcrystalline cellulose, bacterial cellulose, algal cellulose, cotton, pretreated lignocellulose, etc. The most common total cellulolytic activity assay is the filter paper assay using Whatman N51 filter paper as the substrate. The assay was established by the International Union of Pure and Applied Chemistry (IUPAC) (Ghose, 1987, Pure Appl. Chem. 59: 257-68).

### Xyloglucanase

Xyloglucanases are capable of catalyzing the solubilization of xyloglucan to xyloglucan oligo-saccharides. Some xyloglucanases only exhibit xyloglucanase activity, whereas others exhibit both xyloglucanase and cellulase activity. Xyloglucanses may be classified in EC 3.2.1.4 or EC. 3.2.1.151. Enzymes with xyloglucanase activity are for example described in Vincken et al. (1997) Carbohydrate Research 298(4):299-310, wherein three different endoglucanases Endol, EndoV and EndoVI from Trichoderma viride (similar to T. reesei) are characterized. Endol, EndoV and EndoVI belongs to family 5, 7 and 12 of glycosyl hydrolases, respectively, see Henrissat, B. (1991) Biochem. J. 280: 309-316, and Henrissat, B. and Bairoch, A. (1993) Biochem. J. 293: 781-788. WO 94/14953 discloses a family 12 xyloglucanase (EG II) cloned from the fungus Aspergillus aculeatus. WO 99/02663 discloses family 12 and family 5 xyloglucanases cloned from Bacillus licheniformis and Bacillus agaradhaerens, respectively. WO 01/062903 discloses family 44 xyloglucanases.

In particular, WO 99/02663, WO 01/062903 and WO 2009/147210 suggest that xyloglucanases belonging to family 44 of glycosyl hydrolases may be used in detergents. WO 2009/147210 provides xyloglucanase variants.

DNase (deoxyribonuclease)

The term “DNase” means a polypeptide with DNase activity that catalyzes the hydrolytic cleav-age of phosphodiester linkages in the DNA backbone, thus degrading DNA.

### Mannanases

Suitable mannanases include those of bacterial or fungal origin. Chemically or genetically modified mutants are included. The mannanase may be an alkaline mannanase of Family 5 or 26. It may be a wild-type from Bacillus or Humicola, particularly B. agaradhaerens, B. licheniformis, B. halodurans, B. clausii, or H. insolens. Suitable mannanases are described in WO 1999/064619. A commercially available mannanase is Mannaway (Novozymes A/S).

### Proteases

Suitable proteases may be of any origin, but are preferably of bacterial or fungal origin, optionally in the form of protein engineered or chemically modified mutants. The protease may be an alkaline protease, such as a serine protease or a metalloprotease. A serine protease may for example be of the S1 family, such as trypsin, or the S8 family such as a subtilisin. A metalloprotease may for example be a thermolysin, e.g. from the M4 family, or another metalloprotease such as those from the M5, M7 or M8 families.

The term “subtilases” refers to a sub-group of serine proteases according to Siezen et al., Protein Eng. 4 (1991) 719-737 and Siezen et al., Protein Sci. 6 (1997) 501-523. Serine proteases are a subgroup of proteases characterized by having a serine in the active site, which forms a cova-lent adduct with the substrate. The subtilases may be divided into six subdivisions, the Subtilisin family, the Thermitase family, the Proteinase K family, the Lantibiotic peptidase family, the Kexin family and the Pyrolysin family.

Although proteases suitable for detergent use may be obtained from a variety of organisms, including fungi such as Aspergillus, detergent proteases have generally been obtained from bacteria and in particular from Bacillus. Examples of Bacillus species from which subtilases have been derived include Bacillus lentus, Bacillus alkalophilus, Bacillus subtilis, Bacillus amyloliquefaciens, Bacillus licheniformis, Bacillus pumilus and Bacillus gibsonii. Particular subtilisins include subtilisin lentus, subtilisin Novo, subtilisin Carlsberg, subtilisin BPN′, subtilisin 309, subtilisin 147 and subtilisin 168 and e.g. protease PD138 (described in WO 93/18140). Other useful proteases are e.g. those described in WO 01/16285 and WO 02/16547.

Examples of trypsin-like proteases include the Fusarium protease described in WO 94/25583 and WO 2005/040372, and the chymotrypsin proteases derived from Cellumonas described in WO 2005/052161 and WO 2005/052146.

Examples of metalloproteases include the neutral metalloproteases described in WO 2007/044993 such as those derived from Bacillus amyloliquefaciens, as well as e.g. the metalloproteases described in WO 2015/158723 and WO 2016/075078.

Examples of useful proteases are the protease variants described in WO 89/06279 WO 92/19729, WO 96/34946, WO 98/20115, WO 98/20116, WO 99/11768, WO 01/44452, WO 03/006602, WO 2004/003186, WO 2004/041979, WO 2007/006305, WO 2011/036263, WO 2014/207227, WO 2016/087617 and WO 2016/174234. Preferred protease variants may, for example, comprise one or more of the mutations selected from the group consisting of: S3T, V41, S9R, S9E, A15T, S24G, S24R, K27R, N42R, S55P, G59E, G59D, N60D, N60E, V66A, N74D, S85R, A96S, S97G, S97D, S97A, S97SD, S99E, S99D, S99G, S99M, S99N, S99R, S99H, S101A, V1021, V102Y, V102N, S104A, G116V, G116R, H118D, H118N, A120S, S126L, P₁₂₇Q, S128A, S154D, A156E, G157D, G157P, S158E, Y161A, R164S, Q176E, N179E, S182E, Q185N, A188P, G189E, V193M, N198D, V1991, Q200L, Y203W, S206G, L211Q, L211D, N212D, N212S, M216S, A226V, K229L, Q230H, Q239R, N246K, S253D, N255W, N255D, N255E, L256E, L256D T268A and R269H, wherein position numbers correspond to positions of the Bacillus lentus protease shown in SEQ ID NO: 1 of WO 2016/001449. Protease variants having one or more of these mutations are preferably variants of the Bacillus lentus protease (Savinase®, also known as subtilisin 309) shown in SEQ ID NO: 1 of WO 2016/001449 or of the Bacillus amyloliquefaciens protease (BPN′) shown in SEQ ID NO: 2 of WO 2016/001449. Such protease variants preferably have at least 80% sequence identity to SEQ ID NO: 1 or to SEQ ID NO: 2 of WO 2016/001449.

Another protease of interest is the alkaline protease from Bacillus lentus DSM 5483, as described for example in WO 91/02792, and variants thereof which are described for example in WO 92/21760, WO 95/23221, EP 1921147, EP 1921148 and WO 2016/096711.

The protease may alternatively be a variant of the TY145 protease having SEQ ID NO: 1 of WO 2004/067737, for example a variant comprising a substitution at one or more positions corresponding to positions 27, 109, 111, 171, 173, 174, 175, 180, 182, 184, 198, 199 and 297 of SEQ ID NO: 1 of WO 2004/067737, wherein said protease variant has a sequence identity of at least 75% but less than 100% to SEQ ID NO: 1 of WO 2004/067737. TY145 variants of interest are described in e.g. WO 2015/014790, WO 2015/014803, WO 2015/014804, WO 2016/097350, WO 2016/097352, WO 2016/097357 and WO 2016/097354.

Examples of preferred proteases include:
(a) variants of SEQ ID NO: 1 of WO 2016/001449 comprising two or more substitutions selected from the group consisting of S9E, N43R, N76D, Q206L, Y209W, S259D and L262E, for example a variant with the substitutions S9E, N43R, N76D, V2051, Q206L, Y209W, S259D, N261W and L262E, or with the substitutions S9E, N43R, N76D, N185E, S188E, Q191N, A194P, Q206L, Y209W, S259D and L262E, wherein position numbers are based on the numbering of SEQ ID NO: 2 of WO 2016/001449;
(b) a variant of the polypeptide of SEQ ID NO: 1 of WO 2016/001449 with the mutation S99SE, wherein position numbers are based on the numbering of SEQ ID NO: 2 of WO 2016/001449;
(c) a variant of the polypeptide of SEQ ID NO: 1 of WO 2016/001449 with the mutation S99AD, wherein position numbers are based on the numbering of SEQ ID NO: 2 of WO 2016/001449;
(d) a variant of the polypeptide of SEQ ID NO: 1 of WO 2016/001449 with the substitutions Y167A+R170S+A194P, wherein position numbers are based on the numbering of SEQ ID NO: 2 of WO 2016/001449;
(e) a variant of the polypeptide of SEQ ID NO: 1 of WO 2016/001449 with the substitutions S9R+A15T+V68A+N218D+Q245R, wherein position numbers are based on the numbering of SEQ ID NO: 2 of WO 2016/001449;
(f) a variant of the polypeptide of SEQ ID NO: 1 of WO 2016/001449 with the substitutions S9R+A15T+G61 E+V68A+A194P+V205|+Q245R+N261 D, wherein position numbers are based on the numbering of SEQ ID NO: 2 of WO 2016/001449;
(g) a variant of the polypeptide of SEQ ID NO: 1 of WO 2016/001449 with the substitutions S99D+S101R/E+S103A+V1041+G160S; for example a variant of SEQ ID NO: 1 of WO 2016/001449 with the substitutions S3T+V41+S99D+S101E+S103A+V1041+G160S+V2051, wherein position numbers are based on the numbering of SEQ ID NO: 2 of WO 2016/001449;
(h) a variant of the polypeptide of SEQ ID NO: 2 of WO 2016/001449 with the substitutions S24G+S53G+S78N+S101 N+G128A/S+Y217Q, wherein position numbers are based on the numbering of SEQ ID NO: 2 of WO 2016/001449;
(i) the polypeptide disclosed in GENESEQP under accession number BER84782, corresponding to SEQ ID NO: 302 in WO 2017/210295;
(j) a variant of the polypeptide of SEQ ID NO: 1 of WO 2016/001449 with the substitutions S99D+S101E+S103A+V1041+S156D+G160S+L262E, wherein position numbers are based on the numbering of SEQ ID NO: 2 of WO 2016/001449;
(k) a variant of the polypeptide of SEQ ID NO: 1 of WO 2016/001449 with the substitutions S9R+A15T+G61E+V68A+N76D+S99G+N218D+Q245R, wherein position numbers are based on the numbering of SEQ ID NO: 2 of WO 2016/001449;
(l) a variant of the polypeptide of SEQ ID NO: 1 of WO 2016/001449 with the substitutions V68A+S106A, wherein position numbers are based on the numbering of SEQ ID NO: 2 of WO 2016/001449; and
(m) a variant of the polypeptide of SEQ ID NO: 1 of WO 2004/067737 with the substitutions S27K+N109K+S111E+S171E+S173P+G174K+S175P+F180Y+G182A+L184F+Q198E+N199+T297P, wherein position numbers are based on the numbering of SEQ ID NO: 1 of WO 2004/067737.

Suitable commercially available protease enzymes include those sold under the trade names Alcalase®, Duralase™, Durazym™, Relase®, Relase® Ultra, Savinase®, Savinase® Ultra, Pri-mase™, Polarzyme®, Kannase®, Liquanase®, Liquanase® Ultra, Ovozyme®, Coronase®, Coronase® Ultra, Blaze@, Blaze Evity® 100T, Blaze Evity® 125T, Blaze Evity® 150T, Blaze Evity® 200T, Neutrase®, Everlase®, Esperase®, Progress® Uno, Progress@ In and Progress@ Excel (Novozymes A/S), those sold under the tradename Maxatase™, Maxacal™, Maxapem®, Purafect® Ox, Purafect® OxP, Puramax®, FN2™, FN3™, FN4^{ex™} Excellase®, Excellenz™ P1000, Excellenz™ P1250, Eraser™, Preferenz® P100, Purafect Prime, Preferenz P110TM, Effectenz P1000TM Pura-fect®, Effectenz P1050™, Purafect® Ox, Effectenz™ P2000 Purafast™ Properase®, Opticlean™ and Optimase® (Danisco/DuPont), BLAP (sequence shown in FIG. 29 of U.S. Pat. No. 5,352,604) and variants hereof (Henkel A G), and KAP (Bacillus alkalophilus subtilisin) from Kao.

### Lipases and Cutinases

Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 and WO96/27002), P. wis-consinensis (WO96/12012), GDSL-type Streptomyces lipases (WO10/065455), cutinase from Mag-naporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WOO1/92502, WO07/87508 and WO09/109500.

Preferred commercial lipase products include include Lipolase™, Lipex™; Lipolex™ and Lipo-clean™ (Novozymes A/S), Lumafast (DuPont) and Lipomax (Gist-Brocades).

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WO10/100028).

### Amylases

Suitable amylases include an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, 1201, A209 and Q264. Most preferred variants of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 are those having the substitutions:
M197T;
H156Y+A181T+N190F+A209V+Q264S; or
G48A+T491+G107A+H156Y+A181T+N190F+1201F+A209V+Q264S.

Further amylases which are suitable are amylases having SEQ ID NO: 6 in WO 99/019467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, 1206, E212, E216 and K269. Particularly preferred amylases are those having deletion in positions R181 and G182, or positions H183 and G184.

Additional amylases which can be used are those having SEQ ID NO: 1, SEQ ID NO: 3, SEQ ID NO: 2 or SEQ ID NO: 7 of WO 96/023873 or variants thereof having 90% sequence identity to SEQ ID NO: 1, SEQ ID NO: 2, SEQ ID NO: 3 or SEQ ID NO: 7 in WO 96/023873. Preferred variants of the aforementioned SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476, using SEQ ID 2 of WO 96/023873 for numbering. More preferred variants are those having a deletion in two positions selected from 181, 182, 183 and 184, such as 181 and 182, 182 and 183, or positions 183 and 184. Most preferred amylase variants of said SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Other amylases which can be used are amylases having SEQ ID NO: 2 of WO 08/153815, SEQ ID NO: 10 in WO 01/66712 or variants thereof having 90% sequence identity to SEQ ID NO: 2 of WO 08/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further suitable amylases are amylases having SEQ ID NO: 2 of WO 09/061380 or variants having 90% sequence identity to SEQ ID NO: 2 thereof. Preferred variants of SEQ ID NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T1311, T1651, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Most preferred amylase variants of SEQ ID NO: 2 are those having the substitutions:
N128C+K178L+T182G+Y305R+G475K;
N128C+K178L+T182G+F202Y+Y305R+D319T+G475K;
S125A+N128C+K178L+T182G+Y305R+G475K; or
S125A+N128C+T1311+T165|+K178L+T182G+Y305R+G475K wherein the variants are C-ter-minally truncated and optionally further comprises a substitution at position 243 and/or a deletion at position 180 and/or position 181.

Further suitable amylases are amylases having SEQ ID NO: 1 of WO13184577 or variants having 90% sequence identity to SEQ ID NO: 1 thereof. Preferred variants of SEQ ID NO: 1 are those having a substitution, a deletion or an insertion in one of more of the following positions: K176, R178, G179, T180, G181, E187, N192, M199, 1203, S241, R458, T459, D460, G476 and G477. More preferred variants of SEQ ID NO: 1 are those having the substitution in one of more of the following positions: K176L, E187P, N192FYH, M199L, 1203YF, S241QADN, R458N, T459S, D460T, G476K and G477K and/or deletion in position R178 and/or S179 or of T180 and/or G181. Most preferred amylase variants of SEQ ID NO: 1 are those having the substitutions:
E187P+1203Y+G476K
E187P+1203Y+R458N+T459S+D460T+G476K
wherein the variants optionally further comprise a substitution at position 241 and/or a deletion at position 178 and/or position 179.

Further suitable amylases are amylases having SEQ ID NO: 1 of WO10104675 or variants having 90% sequence identity to SEQ ID NO: 1 thereof. Preferred variants of SEQ ID NO: 1 are those having a substitution, a deletion or an insertion in one of more of the following positions: N21, D97, V128 K177, R179, S180, 1181, G182, M200, L204, E242, G477 and G478. More preferred variants of SEQ ID NO: 1 are those having the substitution in one of more of the following positions: N21D, D97N, V1281 K177L, M200L, L204YF, E242QA, G477K and G478K and/or deletion in position R179 and/or S180 or of 1181 and/or G182. Most preferred amylase variants of SEQ ID NO: 1 are those having the substitutions:
N21D+D97N+V1281
wherein the variants optionally further comprise a substitution at position 200 and/or a deletion at position 180 and/or position 181.

Other suitable amylases are the alpha-amylase having SEQ ID NO: 12 in WO01/66712 or a variant having at least 90% sequence identity to SEQ ID NO: 12. Preferred amylase variants are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Other examples are amylase variants such as those described in WO2011/098531, WO2013/001078 and WO2013/001087.

Commercially available amylases are Duramyl™, Termamyl™, Fungamyl™, Stainzyme™ Stainzyme PIus™, Natalase™, Liquozyme X and BAN™ Amplify; Amplify Prime; (from Novozymes A/S), and Rapidase™, Purastar™/Effectenz™, Powerase, Preferenz S1000, Preferenz S100 and Preferenz S110 (from Genencor International Inc./DuPont).

### Oxidases/Peroxidases

Suitable oxidases/peroxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257. Commercially available peroxidases include Guar-dzyme™ (Novozymes A/S).

A suitable peroxidase is preferably a peroxidase enzyme comprised by the enzyme classifica-tion EC 1.11.1.7, as set out by the Nomenclature Committee of the International Union of Biochemistry and Molecular Biology (IUBMB), or any fragment derived therefrom, exhibiting peroxidase activity.

Suitable peroxidases also include a haloperoxidase enzyme, such as chloroperoxidase, bromoperoxidase and compounds exhibiting chloroperoxidase or bromoperoxidase activity. Haloperoxidases are classified according to their specificity for halide ions. Chloroperoxidases (E.C. 1.11.1.10) catalyze formation of hypochlorite from chloride ions.The haloperoxidase may be a chloroperoxidase. Preferably, the haloperoxidase is a vanadium haloperoxidase, i.e., a vanadate-containing haloperoxidase. In a preferred method the vanadate-containing haloperoxidase is combined with a source of chloride ion.

Haloperoxidases have been isolated from many different fungi, in particular from the fungus group dematiaceous hyphomycetes, such as Caldariomyces, e.g., C. fumago, Alternaria, Curvularia, e.g., C. verruculosa and C. inaequalis, Drechslera, Ulocladium and Botrytis.

Haloperoxidases have also been isolated from bacteria such as Pseudomonas, e.g., P. pyrro-cinia and Streptomyces, e.g., S. aureofaciens.

The haloperoxidase may be derivable from Curvularia sp., in particular Curvularia verruculosa or Curvularia inaequalis, such as C. inaequalis CBS 102.42 as described in WO 95/27046; or C. verruculosa CBS 147.63 or C. verruculosa CBS 444.70 as described in WO 97/04102; or from Drechslera hartlebii as described in WO 01/79459, Dendryphiella salina as described in WO 01/79458, Phaeotrichoconis crotalarie as described in WO 01/79461, or Geniculosporium sp. as described in WO 01/79460.

### Licheninases

Suitable licheninases (lichenases) include enzymes that catalyse the hydrolysis of the beta-1,4-glucosidic bonds to give beta-glucans. Licheninases (or lichenases) (e.g. EC 3.2.1.73) hydrolyse (1,4)-beta-D-glucosidic linkages in beta-D-glucans containing (1,3)- and (1,4)-bonds and can act on lichenin and cereal beta-D-glucans.

### Xanthanases

Xanthan gum is a natural polysaccharide consisting of different sugars which are connected by several different bonds, such as b-D-mannosyl-b-D-1,4-glucuronosyl bonds and b-D-glucosyl-b-D-1,4-glucosyl bonds. Xanthan gum is at least partly soluble in water and forms highly viscous solutions or gels. Complete enzymatic degradation of xanthan gum requires several enzymatic activities including xanthan lyase activity and endo-beta-1,4-glucanase activity, preferably a GH9 endoglucanase. Xanthan lyases are enzymes that cleave the b-D-mannosyl-b-D-1,4-glucuronosyl bond of xanthan, whereas the GH9 endoglucanase catalyses the hydrolysis of the glycosyl bond to release smaller sugars.

### Other Materials

Any detergent components known in the art for use in detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in detergents may be utilized. The choice of such ingredients is well within the skill of the artisan.

### Granular Enzyme Formulations

The enzymes may be formulated as a solid/granular enzyme formulation. Non-dusting granulates may be produced, e.g. as disclosed in U.S. Pat. Nos. 4,106,991 and 4,661,452, and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591.

The laccase may be formulated as a granule for example as a co-granule that combines one or more enzymes or benefit agents (such as MnTACN or other bleaching components). Examples of such additional enzymes include lipases, xyloglucanases, perhydrolases, peroxidases, lipoxygenases, laccases, hemicellulases, proteases, care cellulases, cellulases, cellobiose dehydrogenases, xylanases, phospho lipases, esterases, cutinases, pectinases, mannanases, pectate lyases, keratinases, reductases, oxidases, phenoloxidases, ligninases, pullulanases, tannases, pentosanases, lichenases glucanases, arabinosidases, hyaluronidase, chondroitinase, amylases, DNAse, and mixtures thereof. Each enzyme will then be present in more granules securing a more uniform distribution of enzymes in the detergent. This also reduces the physical segregation of different enzymes due to different particle sizes. Methods for producing multi-enzyme co-granulate for the detergent industry are disclosed in the IP.com disclosure IPCOM000200739D.

An embodiment of the invention relates to an enzyme granule/particle comprising a laccase. The granule is composed of a core, and optionally one or more coatings (outer layers) surrounding the core. Typically, the granule/particle size, measured as equivalent spherical diameter (volume based average particle size), of the granule is 20-2000 μm, particularly 50-1500 μm, 100-1500 μm or 250-1200 μm.

The core may include additional materials such as fillers, fibre materials (cellulose or synthetic fibers), stabilizing agents, solubilising agents, suspension agents, viscosity regulating agents, light spheres, plasticizers, salts, lubricants and fragrances. The core may include binders, such as synthetic polymer, wax, fat, or carbohydrate. The core may comprise a salt of a multivalent cation, a reducing agent, an antioxidant, a peroxide decomposing catalyst and/or an acidic buffer component, typically as a homogenous blend. The core may consist of an inert particle with the enzyme absorbed into it, or applied onto the surface, e.g., by fluid bed coating. The core may have a diameter of 20-2000 μm, particularly 50-1500 μm, 100-1500 μm or 250-1200 μm. The core can be prepared by granulating a blend of the ingredients, e.g., by a method comprising granulation techniques such as crystallization, precipitation, pan-coating, fluid bed coating, fluid bed agglomeration, rotary atomiza-tion, extrusion, prilling, spheronization, size reduction methods, drum granulation, and/or high shear granulation. Methods for preparing the core can be found in Handbook of Powder Technology; Particle size enlargement by C. E. Capes; Volume 1; 1980; Elsevier. These methods are well-known in the art and have also been described in international patent application WO2015/028567, pages 3-5, which is incorporated by reference.

The core of the enzyme granule/particle may be surrounded by at least one coating, e.g., to improve the storage stability, to reduce dust formation during handling, or for coloring the granule. The optional coating(s) may include a salt coating, or other suitable coating materials, such as polyethylene glycol (PEG), methyl hydroxy-propyl cellulose (MHPC) and polyvinyl alcohol (PVA). Examples of enzyme granules with multiple coatings are shown in WO 93/07263 and WO 97/23606.

Such coatings are well-known in the art, and have earlier been described in, for example, WO00/01793, WO2001/025412, and WO2015/028567, which are incorporated by reference.

In one aspect, the present invention provides a granule, which comprises:
(a) a core comprising a laccase according to the invention; and
(b) optionally a (salt) coating consisting of one or more layer(s) surrounding the core.

Another aspect of the invention relates to a layered granule, comprising:
(a) a (non-enzymatic) core;
(b) a coating surrounding the core, wherein the coating comprises a laccase; and
(c) optionally a (salt) coating consisting of one or more layer(s) surrounding the enzyme containing coating.

### Encapsulated Enzyme Formulations

The enzymes (laccase and other enzymes present) may also be formulated as an encapsulated enzyme formulation (an ‘encapsulate’). This is particularly useful for separating the enzyme from other ingredients when the enzyme is added into, for example, a (liquid) cleaning composition, such as the detergent compositions described below.

Physical separation can be used to solve incompatibility between the enzyme(s) and other components. Incompatibility can arise if the other components are either reactive against the enzyme, or if the other components are substrates of the enzyme. Other enzymes can be substrates of proteases.

The enzyme may be encapsulated in a matrix, preferably a water-soluble or water dispersible matrix (e.g., water-soluble polymer particles), for example as described in WO 2016/023685. An example of a water-soluble polymeric matrix is a matrix composition comprising polyvinyl alcohol. Such compositions are also used for encapsulating detergent compositions in unit-dose formats.

The enzyme may also be encapsulated in core-shell microcapsules, for example as described in WO 2015/144784, or as described in the IP.com disclosure IPCOM000239419D.

Such core-shell capsules can be prepared using a number of technologies known in the art, e.g., by interfacial polymerization using either a water-in-oil or an oil-in-water emulsion, where polymers are crosslinked at the surface of the droplets in the emulsion (the interface between water and oil), thus forming a wall/membrane around each droplet/capsule.

### Formulation of Enzyme in Co-Granule

The enzymes (laccase and other enzymes present) may be formulated as a granule for example as a co-granule that combines one or more enzymes. Each enzyme will then be present in more granules securing a more uniform distribution of enzymes in the detergent. This also reduces the physical segregation of different enzymes due to different particle sizes. Methods for producing multi-enzyme co-granulates for the detergent industry are disclosed in the IP.com disclosure IPCOM000200739D.

Another example of formulation of enzymes by the use of co-granulates are disclosed in WO 2013/188331, which relates to a detergent composition comprising (a) a multi-enzyme co-granule; (b) less than 10 wt % zeolite (anhydrous basis); and (c) less than 10 wt % phosphate salt (anhydrous basis), wherein said enzyme co-granule comprises from 10 wt % to 98 wt % moisture sink component and the composition additionally comprises from 20 wt % to 80 wt % detergent moisture sink component. WO 2013/188331 also relates to a method of treating and/or cleaning a surface, preferably a fabric surface comprising the steps of (i) contacting said surface with the detergent composition as claimed and described herein in an aqueous wash liquor, (ii) rinsing and/or drying the surface.

The multi-enzyme co-granule may comprise a laccase and (a) one or more enzymes selected from the group consisting of lipases, xyloglucanases, perhydrolases, peroxidases, lipoxygenases, laccases and mixtures thereof; and (b) one or more enzymes selected from the group consisting of hemicellulases, proteases, care cellulases, cellulases, cellobiose dehydrogenases, xylanases, phospho li-pases, esterases, cutinases, pectinases, mannanases, pectate lyases, keratinases, reductases, oxidases, phenoloxidases, ligninases, pullulanases, tannases, pentosanases, lichenases glucanases, arabinosidases, hyaluronidase, chondroitinase, amylases, DNAse, and mixtures thereof.

### Purity of Enzyme in Formulations

The enzyme of the present invention used in the above-mentioned enzyme formulations may be purified to any desired degree of purity. This includes high levels of purification, as achieved for example by using methods of crystallization—but also none or low levels of purification, as achieved for example by using crude fermentation broth, as described in WO 2001/025411, or in WO 2009/152176.

### Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

The detergent enzyme(s) may be included in a detergent composition by adding separate addi-tives containing one or more enzymes, or by adding a combined additive comprising all of these enzymes. A detergent additive of the invention, i.e., a separate additive or a combined additive, can be formulated, for example, as a granulate, liquid, slurry, etc. Preferred detergent additive formulations are granulates, in particular non-dusting granulates, liquids, in particular stabilized liquids and, or slurries.

Non-dusting granulates may be produced, e.g. as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water-soluble acrylate copolymers, methyl cellulose, carboxy methyl cellulose, sodium dextrin, ethyl cellulose, hy-droxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water-soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water-soluble film. The compartment for liquid components can be different in composition than compartments containing solids. Ref: (US2009/0011970 A1).

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent. A liquid or gel detergent may be non-aqueous.

### Use in Detergents.

The polypeptides of the present invention may be added to and thus become a component of a detergent composition.

The detergent composition of the present invention may be formulated, for example, as a hand or machine laundry detergent composition including a laundry additive composition suitable for pre-treat-ment of stained fabrics or for rejuvenating textile (e.g. by fuzz or pill removal) to restore some of the visual and feel properties of fabrics after extended use to match that of a new textile, and a rinse added fabric softener composition, or be formulated as a detergent composition for use in general household hard surface cleaning operations, or be formulated for hand or machine dishwashing operations.

Further, in WO 2022/184568 it is disclosed that the addition of cellulase enzymes to consumer products can improve the deposition of fragrance on to textiles. This use of the polypeptides of the present invention is also encompassed.

### Washing Method

The detergent compositions of the present invention are ideally suited for use in laundry applications. Accordingly, the present invention includes a method for laundering a fabric. The method comprises the steps of contacting a fabric to be laundered with a cleaning laundry solution comprising the detergent composition according to the invention. The fabric may comprise any fabric capable of being laundered in normal consumer use conditions. The solution preferably has a pH of from about 5.5 to about 8. The compositions may be employed at concentrations of from about 100 ppm, preferably 500 ppm to about 15,000 ppm in solution. The water temperatures typically range from about 5° C. to about 90° C., including about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C. and about 90° C. The water to fabric ratio is typically from about 1:1 to about 30:1.

In particular embodiments, the washing method is conducted at a pH of from about 5.0 to about 11.5, or in alternative embodiments, even from about 6 to about 10.5, such as about 5 to about 11, about 5 to about 10, about 5 to about 9, about 5 to about 8, about 5 to about 7, about 5.5 to about 11, about 5.5 to about 10, about 5.5 to about 9, about 5.5 to about 8, about 5.5. to about 7, about 6 to about 11, about 6 to about 10, about 6 to about 9, about 6 to about 8, about 6 to about 7, about 6.5 to about 11, about 6.5 to about 10, about 6.5 to about 9, about 6.5 to about 8, about 6.5 to about 7, about 7 to about 11, about 7 to about 10, about 7 to about 9, or about 7 to about 8, preferably about 5.5 to about 9, and more preferably about 6 to about 8.

In particular embodiments, the washing method is conducted at a degree of hardness of from about 0° dH to about 30° dH, such as about 1° dH, about 2° dH, about 3° dH, about 4° dH, about 5° dH, about 6° dH, about 7° dH, about 8° dH, about 9° dH, about 10° dH, about 11° dH, about 12° dH, about 13° dH, about 14° dH, about 15° dH, about 16° dH, about 17° dH, about 18° dH, about 19° dH, about 20° dH, about 21° dH, about 22° dH, about 23° dH, about 24° dH, about 25° dH, about 26° dH, about 27° dH, about 28° dH, about 29° dH,about 30° dH. Under typical European wash conditions, the degree of hardness is about 15° dH, under typical US wash conditions about 6° dH, and under typical Asian wash conditions, about 3° dH.

The present invention relates to a method of cleaning a fabric, a dishware or hard surface with a detergent composition comprising a mannanase variants of the invention.

A preferred embodiment concerns a method of cleaning, said method comprising the steps of: contacting an object with a cleaning composition comprising a mannanase variants of the invention under conditions suitable for cleaning said object. In a preferred embodiment the cleaning composition is a detergent composition and the process is a laundry or a dish wash process.

Still another embodiment relates to a method for removing stains from fabric which comprises contacting said a fabric with a composition comprising a mannanase variants of the invention under conditions suitable for cleaning said object.

### Low Temperature Uses

One embodiment of the invention concerns a method of doing laundry, dish wash or industrial cleaning comprising contacting a surface to be cleaned with a mannanase variants of the invention, and wherein said laundry, dish wash, industrial or institutional cleaning is performed at a temperature of about 40° C. or below. One embodiment of the invention relates to the use of a mannanase in laundry, dish wash or a cleaning process wherein the temperature in laundry, dish wash, industrial cleaning is about 40° C. or below.

In another embodiment, the invention concerns the use of a mannanase according to the invention in a protein removing process, wherein the temperature in the protein removing process is about 40° C. or below.

In each of the above-identified methods and uses, the wash temperature is about 40° C. or below, such as about 39° C. or below, such as about 38° C. or below, such as about 37° C. or below, such as about 36° C. or below, such as about 35° C. or below, such as about 34° C. or below, such as about 33° C. or below, such as about 32° C. or below, such as about 31° C. or below, such as about 30° C. or below, such as about 29° C. or below, such as about 28° C. or below, such as about 27° C. or below, such as about 26° C. or below, such as about 25° C. or below, such as about 24° C. or below, such as about 23° C. or below, such as about 22° C. or below, such as about 21° C. or below, such as about 20° C. or below, such as about 19° C. or below, such as about 18° C. or below, such as about 17° C. or below, such as about 16° C. or below, such as about 15° C. or below, such as about 14° C. or below, such as about 13° C. or below, such as about 12° C. or below, such as about 11° C. or below, such as about 10° C. or below, such as about 9° C. or below, such as about 8° C. or below, such as about 7° C. or below, such as about 6° C. or below, such as about 5° C. or below, such as about 4° C. or below, such as about 3° C. or below, such as about 2° C. or below, such as about 1° C. or below.

In another preferred embodiment, the wash temperature is in the range of about 5-40° C., such as about 5-30° C., about 5-20° C., about 5-10° C., about 10-40° C., about 10-30° C., about 10-20° C., about 15-40° C., about 15-30° C., about 15-20° C., about 20-40° C., about 20-30° C., about 25-40° C., about 25-30° C., or about 30-40° C. In particular preferred embodiments the wash temperature is about 20° C., about 30° C., or about 40° C.

### EXAMPLES

### Materials and Methods

Composition of model detergent I (powder)

Composition of detergent I (powder): Ingredients: 17.6% LAS, 2.2% AEO (NI), 20.1% Soda ash, 12.4% sodium silicate, 16.3% zeolite, 31.4% sodium sulfate (all percentages are w/w).

### Composition of Model Detergent II (Liquid)

Composition of detergent II (liquid): Ingredients: 12% LAS, 12% AEO Biosoft N25-7 (NI), 4% AEOS (SLES), 2% MPG (monopropylene glycol), 3% ethanol, 2% TEA (triethyl amine), 3% soap, 0.5% sodium hydroxide, 3.9% sodium citrate, 1.5% DTMPA, Na7 (diethylenetriaminepentakis (meth-ylene)pentakis(phosphonic acid), heptasodium salt), 0.5% phenoxyethanol, water to 100% (all percentages are w/w).

### Assay for Laccase Activity

The activity of laccase may be determined using 2,2′-azino-bis (3-ethylbenzothiazoline-6-sulfonic acid) diammonium salt, (ABTS, CAS number: 30931-67-0) as substrate. A 3.0 mM stock solution of the ABTS is prepared by mixing 16.5 mg of the ABTS with 10 ml of 100 mM sodium acetate pH 4. The reaction is started by adding 100 μl of laccase sample into 60 μl of the ABTS stock solution. A substrate control and enzyme control are included. The reaction is incubated at room temperature for 10 minutes. Absorbance at 405 nm is measured using e.g., a SPECTRAMAX@ Microplate Reader (Molecular Devices, Sunnyvale, CA, USA), and the result are used to calculate the activity of laccase.

### Wash Assays

### Terg-O-Tometer (TOM) Wash Assay

The Terg-O-tometer (TOM) is a medium scale model wash system that can be applied to test 16 different wash conditions simultaneously. A TOM is basically a large temperature-controlled water bath with up to 16 open metal beakers submerged into it. Each beaker constitutes one small top loader style washing machine and during an experiment, each of them will contain a solution of a specific detergent/enzyme system and the soiled and unsoiled fabrics its performance is tested on. Mechanical stress is achieved by a rotating stirring arm, which stirs the liquid within each beaker. Because the TOM beakers have no lid, it is possible to withdraw samples during a TOM experiment and assay for information on-line during wash.

The TOM model wash system is mainly used in medium scale testing of detergents and enzymes at EU or US or LA/AP wash conditions. In a TOM experiment, factors such as the ballast to soil ratio and the fabric to wash liquor ratio can be varied. Therefore, the TOM provides the link between small scale experiments, such as AMSA and mini-wash, and the more time-consuming full-scale experiments in top or front loader washing machines.

Equipment: The water bath with 16 steel beakers and 1 rotating arm per beaker with capacity of 500 to 1200 mL of detergent solution. Temperature ranges from 5 to 80° C. The water bath has to be filled up with deionised water. Rotational speed can be set up to 70 to 200 rpm/min.

Set temperature in the Terg-O-tometer and start the rotation in the water bath. Wait for the temperature to adjust (tolerance is +/−0,5° C.). All beakers shall be clean and without traces of prior test material.

The wash solution with desired amount of detergent, temperature and water hardness was prepared in a bucket. The detergent was allowed to dissolve during magnet stirring for 10 min. Wash solution shall be used within 30 to 60 min after preparation.

1000 ml wash solution was added into a TOM beaker. The wash solution was agitated at 150 rpm and optionally one or more enzymes or ingredients are added to the beaker. The swatches consisting of various colored test fabrics are sprinkled into the beaker along with the ballast load. Time measurement starts when the fabrics and ballast are added to the beaker. The fabrics are washed for 20 minutes after which agitation was terminated. The wash load was subsequently transferred from the TOM beaker to a sieve and rinse with cold tap water. The test fabrics are separated from the ballast load and transferred to a 5 L beaker with cold tap water under running water for 5 minutes. The ballast load was kept separately for the coming inactivation. The water was gently pressed out of the fabrics by hand and placed on a tray covered with a paper. Another paper was placed on top of the fabrics. They are allowed to dry overnight before subjecting the fabrics to analysis, such as measuring the color intensity using a DataColor or ColorEye.

### Method for Evaluation of Fabric Color Care Benefits

Wash performance was expressed as a delta remission value (ΔRem). After washing and rinsing the swatches are spread out flat and allowed to air dry at room temperature overnight. Light reflectance evaluations of the dry swatches are done using a Macbeth Color Eye 7000 reflectance spectrophotometer with very small aperture. The measurements are made without UV in the incident light and remission at 460 nm is extracted. Measurement with small aperture through 2 layers (2 of the same type of swatch from the same beaker), 1 measurement on each swatch on the front side marked with beaker and swatch number. Calculating the enzyme and ingredient effect is done by taking the measurements from washed swatches with enzymes and/or ingredients to be tested and subtract with the measurements from washed without enzyme or ingredient for each stain. Best color care effects are indicated by lower delta remission values, with higher values indicating fuzzy and pilled fabric. The total enzyme performance is calculated as the average of individual delta remission values.

### Method for Evaluation of Fabric Softness Benefits

Fabric softness was measured by panel scoring, where a ‘soft feel’ was determined by applying a light pressure on the fabric by touching and rubbing the surface. Based on the ease of yielding to pressure the panel scores were set from 1-5, with 1 being stiff and 5 being soft to touch. Three panelists participated in each test.

The fabrics include a combination of cotton, polycotton and synthetic standard textiles. The commercial test materials are available from Center for Testmaterials BV, Stoomloggerweg 11, 3133 KT Vlaardingen, the Netherlands. AISE (14) dye set used as per recommendations of revised EU Ecolabel performance test for laundry detergents, final draft, version of Jun. 20, 2014.

| Fabric | |
|---|---|
| and Tracer | |
| material | Type |
| CN-42U | Cotton, interlock, double jersey, without optical brightener |
| W-80A | Cotton, knitwear |
| AISE1 | Sulphur Black |
| AISE3 | Vat Green |
| AISE5 | Vat Blue |
| AISE 8 | Direct Yellow + cationic after-treatment (Tinofix ECO) |
| AISE 16 | Reactive Red |
| AISE 20 | Reactive Black (pale shade) |
| AISE 21 | Reactive Black (heavy shade) |
| AISE 22 | Reactive Orange |
| AISE 24 | Reactive Blue |
| AISE 26 | Reactive Violet |
| AISE 27 | Reactive trichromatic combination |
| AISE 29 | Reactive trichromatic combination |
| AISE 33 | Disperse Navy + heat set |
| AISE 39 | Acid Red + syntan |

### Example 1: Wash Performance Using Laccase in Powder Detergent

The wash solution measuring up to 1 L with desired amount of detergent, enzyme and/or in-gradient to be tested, temperature and water hardness was prepared in a TOM beaker. The detergent was allowed to dissolve during magnetic stirring for 5 minutes. Wash solution was used within 30 to 60 minutes after preparation.

Fabric ballast along with the tracer fabrics was added to the wash drum and wash initiated. Details of the wash program are as follows:

| Wash Equipment | TOM | |
|---|---|---|
| Detergent Model I (g/L) | 2 | |
| Temperature (° C.) | 30 | |
| Wash liquor (L) | 1 | L |

| | |
|---|---|
| Wash time (min) | 20 |
| Hardness (° dH) | 15 |
| Ca:Mg:Na | 2.0:1.0:4.5 |
| Ballast (g) | Up to 25 g |
| Cycle/Repetition | 10 |
| Fabrics | EMPA 252 (unpilled), EMPA 252 (pilled), |
| | BKC-01, AISE-14 dye set (colored fabric) |
| Tracers | CN-42U, W-80A |
| Tracer and Fabric | 1 pc for EMPA and BKC fabric; 2 pcs for |
| (pcs/wash) | the AISE-14 dye set |
| Wash type | Multi-cycle |

Enzyme or ingredients to be tested

| Laccase system | Myceliophthora thermophila laccase | |
|---|---|---|
| | having Uniprot accession number | |
| | G2QG31 (0.02 mg), 3.56 mg NaH₂PO₄, | |
| | 0.7 mg Methyl syringate | |
| Endoglucanase A | SEQ ID NO: 1, 0.04 mg | |
| Endoglucanase B | SEQ ID NO: 2, 0.05 mg | |
| Sodium dihydrogen | 3.56 | mg |
| phosphate (NaH₂PO₄) | | |
| Sodium triphosphate (STP) | 3.56 | mg |

Wash performance with respect to colour care is expressed as a remission value (Rem460), whereas softness is evaluated via panel scoring. Results as shown in table 1 a below clearly indicates superior color care and softness benefit provided by including Laccase system or NaH2PO4 in the wash. Lower remission values indicate ‘darker colors’, hence color maintenance. Conversely, higher remission values indicate ‘fuzzy or pilled surface’.

For example, the Rem46 of an AISE-5 fabric washed with Model I detergent only was approx-imately 32 units as compared to 29.5 units with Model I and dihydrogen phosphate and 29 units with Model I and Laccase system.

Fabric softness as opposed to stiffness was measured by panel scoring, with 1 being stiff and 5 being the softest to yield to touch. Results as shown in table 1b below clearly indicates superior softness benefit provided by including Laccase enzyme and NaH₂PO4 in the wash.

For example, the score for an AISE-5 fabric washed with Model I was 1 as compared to 3.5 with Model I and dihydrogen phosphate and 4 with Model I and Laccase system.

TABLE 1a
Wash performance using different colored fabrics.

| Samples | AISE 1 | AISE 3 | AISE 5 | AISE 8 |
|---|---|---|---|---|
| Laccase system | 3.60 | 16.65 | 28.94 | 12.87 |
| NaH₂PO₄ | 4.13 | 16.73 | 29.45 | 12.42 |
| Endoglucanase A | 4.61 | 18.78 | 31.51 | 14.27 |
| Endoglucanase A + | 3.43 | 17.43 | 29.56 | 12.68 |
| NaH₂PO₄ | | | | |
| Endoglucanase B | 4.37 | 18.56 | 31.26 | 14.16 |
| Endoglucanase B + | 3.23 | 16.63 | 29.23 | 12.46 |
| NaH₂PO₄ | | | | |
| STP | 3.43 | 17.16 | 29.72 | 12.61 |
| Model I | 4.42 | 18.54 | 31.88 | 14.17 |

| Samples | AISE 16 | AISE 20 | AISE 21 | AISE 22 |
|---|---|---|---|---|
| Laccase system | 10.73 | 24.15 | 8.01 | 10.29 |
| NaH2PO4 | 11.14 | 24.20 | 8.51 | 9.98 |
| Endoglucanase A | 13.34 | 27.29 | 10.16 | 12.16 |
| Endoglucanase A + | 11.19 | 24.57 | 8.41 | 10.42 |
| NaH₂PO₄ | | | | |
| Endoglucanase B | 12.94 | 26.29 | 9.93 | 12.35 |
| Endoglucanase B + | 10.80 | 24.21 | 8.29 | 9.95 |
| NaH₂PO₄ | | | | |
| STP | 11.04 | 24.49 | 8.61 | 10.31 |
| Model I | 13.32 | 26.31 | 9.97 | 12.48 |
| Samples | AISE 24 | AISE 26 | AISE 27 | AISE 29 |
| Laccase system | 60.22 | 42.32 | 3.97 | 6.70 |
| NaH₂PO₄ | 60.35 | 42.39 | 4.17 | 6.55 |
| Endoglucanase A | 62.13 | 45.71 | 5.50 | 8.18 |
| Endoglucanase A + | 59.70 | 42.30 | 4.23 | 6.90 |
| NaH₂PO₄ | | | | |
| Endoglucanase B | 62.58 | 45.08 | 5.35 | 8.13 |
| Endoglucanase B + | 60.32 | 41.98 | 3.98 | 6.77 |
| NaH₂PO₄ | | | | |
| STP | 60.81 | 42.65 | 4.04 | 6.84 |
| Model I | 62.19 | 46.11 | 5.30 | 8.33 |

| | | | | EMPA | EMPA |
|---|---|---|---|---|---|
| Samples | AISE 33 | AISE 39 | BKC01 | 252 | 252 PA |
| Laccase system | 6.48 | 2.82 | 24.24 | 8.04 | 3.79 |
| NaH₂PO₄ | 6.49 | 2.70 | 25.3 | 8.13 | 3.89 |
| Endoglucanase A | 6.60 | 2.75 | 28.41 | 6.54 | 4.46 |
| Endoglucanase A + | 6.46 | 2.81 | 24.3 | 6.08 | 4.13 |
| NaH₂PO₄ | | | | | |
| Endoglucanase B | 6.47 | 2.75 | 29.28 | 12.12 | 4.77 |
| Endoglucanase B + | 6.62 | 2.77 | 24.39 | 8 | 3.9 |
| NaH₂PO₄ | | | | | |
| STP | 6.61 | 2.81 | 25.39 | 8.88 | 4.1 |
| Model I | 6.57 | 2.77 | 30.69 | 13.2 | 4.51 |

TABLE 1b
Softness measurements

| Samples | AISE 1 | AISE 3 | AISE 5 | AISE 8 |
|---|---|---|---|---|
| Laccase system | 4 | 3.5 | 4 | 4 |
| NaH₂PO₄ | 3 | 3 | 3.5 | 3 |
| Endoglucanase A | 3 | 3.5 | 3.5 | 4 |
| Endoglucanase A + | 3.5 | 4 | 4 | 4.5 |
| NaH₂PO₄ | | | | |
| Endoglucanase B | 3 | 3 | 3 | 3 |
| Endoglucanase B + | 3.5 | 3.5 | 3.5 | 3.5 |
| NaH₂PO₄ | | | | |
| STP | 2.5 | 3 | 3 | 3 |
| Model I | 1 | 2 | 1 | 2 |

| Samples | AISE 16 | AISE 20 | AISE 21 | AISE 22 |
|---|---|---|---|---|
| Laccase system | 4 | 4 | 4 | 5 |
| NaH₂PO₄ | 3.5 | 3.5 | 3 | 4 |
| Endoglucanase A | 3.5 | 3.5 | 3.5 | 3 |
| Endoglucanase A + | 4 | 4 | 4 | 3.5 |
| NaH₂PO₄ | | | | |
| Endoglucanase B | 3 | 3.5 | 3.5 | 3 |
| Endoglucanase B + | 3.5 | 4 | 4 | 3.5 |
| NaH₂PO₄ | | | | |
| STP | 3 | 3 | 3 | 3 |
| Model I | 1 | 1 | 2 | 1 |
| Samples | AISE 24 | AISE 26 | AISE 27 | AISE 29 |
| Laccase system | 3.5 | 4 | 4 | 3.5 |
| NaH₂PO₄ | 3 | 3.5 | 3.5 | 3 |
| Endoglucanase A | 3.5 | 3.5 | 3 | 3 |
| Endoglucanase A + | 4 | 4 | 4 | 3.4 |
| NaH₂PO₄ | | | | |
| Endoglucanase B | 3 | 3.5 | 3.5 | 3 |
| Endoglucanase B + | 3.5 | 4 | 4 | 3.5 |
| NaH₂PO₄ | | | | |
| STP | 2 | 3 | 3 | 3 |
| Model I | 1 | 1 | 1 | 1 |

| | | | | EMPA | EMPA |
|---|---|---|---|---|---|
| Samples | AISE 33 | AISE 39 | BKC01 | 252 | 252 PA |
| Laccase system | 4 | 4 | 4 | 3.5 | 3 |
| NaH₂PO₄ | 3.5 | 3.5 | 3 | 3 | 3 |
| Endoglucanase A | 3.5 | 3.5 | 4 | 3 | 4 |
| Endoglucanase A + | 4 | 4 | 4.5 | 3.5 | 4.5 |
| NaH₂PO₄ | | | | | |
| Endoglucanase B | 3 | 3 | 2 | 2.5 | 2 |
| Endoglucanase B + | 3.5 | 3.5 | 3 | 3 | 2.5 |
| NaH₂PO₄ | | | | | |
| STP | 3 | 3 | 3 | 3 | 2 |
| Model I | 1 | 1 | 2 | 2 | 1 |

### Example 2: Wash Performance Using Laccase and Dihydrogen Phosphate and Benchmarking Against Commercial Detergents (Liquids and Powder)

The “wash solution” measuring up to L with desired amount of detergent, enzyme and/or ingredient, temperature and water hardness was prepared in a TOM beaker. The detergent was allowed to dissolve during magnetic stirring for 5 min. Wash solution shall be used within 30 to 60 min after preparation.

Fabric ballast along with the tracer fabrics was added to the wash drum and wash initiated. Details of the wash program are as follows:

| | |
|---|---|
| Wash Equipment | TOM |
| Detergent: Model I and | 2 |
| commercially available | |
| detergents (g/L) | |
| Detergent: Model II (g/L) | 3.33 |
| Temperature (° C.) | 30 |
| Wash liquor (L) | 1 L |
| Wash time (min) | 30 |
| Hardness (°dH) | 15 |
| Ca:Mg:Na | 2.0:1.0:4.5 |
| Ballast (g) | Up to 25 g |
| Cycle/Repetition | 12 |
| Fabrics | EMPA 252 (unpilled), EMPA 252 (pilled), |
| | BKC-01, AISE-14 dye set (colored fabric) |
| Tracers | CN-42U, W-80A |
| Tracer and Fabric | 1 pc for EMPA and BKC fabric; 2 pcs for |
| (pcs/wash) | the AISE-14 dye set |
| Wash type | Multi-cycle |
| Laccase system | Myceliophthora thermophila laccase |
| | having Uniprot accession number |
| | G2QG31 (0.04 mg), 3.56 mg NaH₂PO₄, |
| | 0.7 mg Methyl syringate |

Wash performance is expressed as a remission value (Rem460) or via panel scoring. Results as shown in Table 2a below clearly indicates superior color care benefit provided by including Laccase system or NaH2PO4 in the wash. Lower remission values indicate ‘darker colors’, hence color maintenance. Conversely, higher remission values indicate ‘fuzzy or pilled surface’.

For example, the Rem46 of an AISE-5 fabric washed with Model I detergent only was approx-imately 36units as compared to 33units with Model I and Laccase system. The color on fabrics after 12 wash cycles was on-par with a commercial liquid or powder detergent containing special ingredients like polymers and care enzymes.

Fabric softness as opposed to stiffness was measured by panel scoring, with 1 being stiff and 5 being the softest to yield to touch. Results as shown in table 2b below clearly indicates superior softness benefit provided by including Laccase enzyme and NaH2PO4 in the wash.

For example, the score for an AISE-5 fabric washed with Model I was 2 as compared to 3.5 with Model I and Laccase system.

TABLE 2a
Wash performance using different colored fabrics.

| Sample | Condition | AISE-1 | AISE-3 | AISE-5 | AISE-8 | AISE-16 |
|---|---|---|---|---|---|---|
| Model I | Blank | 5.67 | 9.37 | 36.35 | 14.12 | 16.16 |
| Model I | Laccase system | 3.61 | 7.53 | 32.87 | 11.78 | 12.70 |
| Model II | Blank | 3.45 | 7.36 | 32.81 | 11.34 | 12.64 |
| Comfort | Blank | 3.39 | 7.29 | 31.07 | 9.92 | 12.28 |
| Love & Care | Blank | 3.66 | 7.44 | 32.23 | 11.08 | 12.69 |
| Henko Lintelligent | Blank | 3.83 | 7.48 | 28.34 | 12.25 | 12.10 |

| Sample | Condition | AISE-26 | AISE-27 | BKC-01 | E-252 | E-252 PA |
|---|---|---|---|---|---|---|
| Model I | Blank | 51.73 | 6.12 | 31.60 | 8.24 | 13.27 |
| Model I | Laccase system | 47.46 | 3.85 | 23.81 | 5.30 | 8.54 |
| Model II | Blank | 46.38 | 3.74 | 24.45 | 4.66 | 8.44 |
| Comfort | Blank | 44.77 | 3.80 | 23.97 | 3.97 | 8.26 |
| Love & Care | Blank | 46.20 | 3.83 | 24.26 | 5.78 | 8.50 |
| Henko Lintelligent | Blank | 38.92 | 3.68 | 24.85 | 5.81 | 8.89 |

TABLE 2b
Softness measurements.

| Sample | Condition | AISE-1 | AISE-3 | AISE-5 | AISE-8 | AISE-16 |
|---|---|---|---|---|---|---|
| Model I | Blank | 2 | 3 | 2 | 3 | 2 |
| Model I | Laccase system | 4 | 4 | 3.5 | 4 | 4 |
| Model II | Blank | 3 | 4 | 3.5 | 4 | 3.5 |
| Comfort | Blank | 3.5 | 4 | 4 | 3 | 4 |
| Love & Care | Blank | 4 | 4 | 4 | 3.5 | 4 |
| Henko Lintelligent | Blank | 4 | 4 | 4 | 4 | 4 |

| Sample | Condition | AISE-26 | AISE-27 | BKC-01 | E-252 | E-252 PA |
|---|---|---|---|---|---|---|
| Model I | Blank | 2 | 2 | 1 | 1.5 | 1 |
| Model I | Laccase system | 4 | 4 | 4.5 | 4 | 3 |
| Model II | Blank | 3.5 | 3.5 | 4 | 4 | 3 |
| Comfort | Blank | 2 | 4 | 3.5 | 4 | 3 |
| Love & Care | Blank | 4 | 4 | 4.5 | 4 | 3 |
| Henko Lintelligent | Blank | 4 | 4 | 4.5 | 4 | 3 |

Commercial benchmark detergents were chosen based on their care and gentle claims. Com-fort is a commercial fabric conditioner that claims to give clothes long-lasting freshness and extra-special softness. Love & care is an expert care wash formula tailormade to be gentle on fabrics such as cotton, preventing pilling of fibres. Henko LINTelligent claims a unique ‘Nano Fibre Lock Technology’ that locks fraying fibres and conditions them to keep color and sheen intact.

The invention described and claimed herein is not to be limited in scope by the specific aspects herein disclosed, since these aspects are intended as illustrations of several aspects of the invention. Any equivalent aspects are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

1. A detergent composition comprising:
1) less phosphate than the amount of phosphate corresponding to 0.2% STP;
2) an enzyme having laccase activity and optionally at least one more enzyme;
3) at least one surfactant; and
4) optionally a laccase oxidase mediator.

2. The detergent composition according to claim 1, wherein the enzyme having laccase activity has a TM-score of at least 0.60, e.g., at least 0.65, at least 0.70, at least 0.75, at least 0.80, at least 0.85, at least 0.90, at least 0.91, at least 0.92, at least 0.93, at least 0.94, at least 0.95, at least 0.96, at least 0.97, at least 0.98, at least 0.99, or even 1.0, compared to the three-dimensional structure of the polypeptide having UniProt accession number G2QG31.

3. The detergent composition according to claim 1 comprising a laccase oxidase mediator, preferably selected from the group consisting of diammonium salt of 2,2′-azine-bis(3-ethylbenzothiazoline-6-sulfonic acid (ABTS), methyl syringate, 2,2′,6,6′-tetramethyl-1-piperidinyloxyl (TMPO), 1-hydroxybenzotriazole (HBT), 3-hydroxyanthranilic acid, 3-hydroxyanthranilic acid (HPI), violuric acid (VA), phenothiazine, phenothiazine-10-propionic acid, promazine, chloropromazine, and 1-nitroso-2-naphthol-3,6-disulfonic acid, and 2-nitroso-1-naphthol-4-sulfonic acid.

4. The detergent composition according to claim 1, wherein the at least one surfactant is a biobased surfactant.

5. The detergent composition according to claim 4, wherein the biobased surfactant is selected from the group consisting of rhamnolipid and sophorolipid.

6. The detergent composition according to claim 1, wherein the composition comprises at least one additional enzyme selected from the group consisting of protease, lipase, cutinase, amylase, cellulase, DNase, pectinase, mannanase, arabinase, galactanase, xyloglucanase, xanthanase, li-cheninase, and peroxidase.

7. The detergent composition according to claim 1, wherein the laccase and optionally least one additional enzyme is in the form of liquid enzyme preparations, encapsulated enzyme formulations or granular enzyme formulations, the latter also in the form of co-granulates.

8. The detergent composition according to claim 1 in the form of a powder detergent, liquid detergent, or soap bar.

9. A method of cleaning laundry or a hard surface, the method comprising contacting a detergent composition of claim 1 with an item to be cleaned.

10. The method of claim 9, wherein the hard surface is a dish.

11. A method of laundering an item, the method comprising contacting a detergent composition of claim 1 with an item to be laundered.

12. The method of claim 11, wherein the method of laundering comprises color care or obtaining softness of the item, wherein the item is a textile.

13. A method of cleaning an item, comprising exposing the item to a wash liquor comprising the detergent composition according to claim 1, preferably wherein the item is a textile or a hard surface.


SEQUENCE LISTING (2 sequences)

SEQ ID NO: 1 - protein, 278 aa, Thermothielavioides terrestris [sequence omitted]

SEQ ID NO: 2 - protein, 415 aa, Humicola insolens
QKPGETKEVHPQLTTFRCTKRGGCKPATNFIVLDSLSHPIHRAEGLGPGGCGDWGNPPPKDVCPDVESCAKNCIMEGIPDYSQYGVTTNGTSLRLQHILPDGRVPSPRVYLLDKTKRRYEMLHLTGFEFTFDVDATKLPCGMNSALYLSEMHPTGAKSKYNPGGAYYGTGYCDAQCFVTPFINGLGNIEGKGSCCNEMDIWEANSRASHVAPHTCNKKGLYLCEGEECAFEGVCDKNGCGWNNYRVNVTDYYGRGEEFKVNTLKPFTVVTQFLANRRGKLEKIHRFYVQDGKVIESFYTNKEGVPYTNMIDDEFCEATGSRKYMELGATQGMGEALTRGMVLAMSIWWDQGGNMEWLDHGEAGPCAKGEGAPSNIVQVEPFPEVTYTNLRWGEIGSTYQEVQKPKPKPGHGPRSD